(19) United States
(12) Patent Application Publication
(10) Pub. No.: US 2024/0385471 A1
(43) Pub. Date: Nov. 21, 2024

(54) OPTICAL MODULATOR INCLUDING A GRAPHENE LAYER AND METHOD FOR MODULATING AN ELECTROMAGNETIC RADIATION

(71) Applicants: CAMGRAPHIC SRL, Monza (MB) (IT); CONSORZIO NAZIONALE INTERUNIVERSITARIO PER LE TELECOMUNICAZIONI, Parma (IT)

(72) Inventors: Marco ROMAGNOLI, Milano (IT); Vito SORIANELLO, San Giuliano Terme (PI) (IT); Alessio PIRASTU, Pisa (IT)

(73) Assignees: CAMGRAPHIC SRL, Monza (MB) (IT); CONSORZIO NAZIONALE INTERUNIVERSITARIO PER LE TELECOMUNICAZIONI, Parma (IT)

(21) Appl. No.: 18/690,291

(22) PCT Filed: Sep. 6, 2022
(86) PCT No.: PCT/EP2022/074709

§ 371 Date: Mar. 8, 2024

(30) Foreign Application Priority Data
Sep. 10, 2021 (IT) 102021000023423

(51) Int. Cl. G02F 1/035; G02F 1/03

(52) U.S. Cl. CPC G02F 1/035; G02F 1/0316; G02F 2202/02

(57) ABSTRACT

A segmented optical modulator includes:
a waveguide where electromagnetic radiation to be modulated is adapted to travel along a travelling direction;
between 2 and 30 modulating segments each including:
first and second layers of graphene, a portion of the first layer of graphene overlaying a portion of the second and the first and second layers of graphene overlaying a portion of the waveguide;
a dielectric layer interposed between the first and second layers of graphene, the dielectric layer having a thickness between 6 nm EOT and 15 nm EOT;
a first metal electrode in contact with the first layer of graphene;
a second metal electrode in contact with the second layer of graphene;
the distance between the first and second electrodes being between 650 nm and 1500 nm;
the length of each segment in the travelling direction being between 10 micrometers and 60 micrometers.

### TECHNICAL FIELD

The present invention relates to an optical modulator including a graphene layer. The optical modulator is segmented. Furthermore, the invention relates to a method to modulate an electromagnetic radiation using an optical modulator having a graphene layer and being modulated.

### TECHNOLOGICAL BACKGROUND

Optical modulators are apparatuses for transmitting information by changing the characteristics of an electromagnetic radiation. Possible characteristics to be changed are for example the intensity of the electromagnetic radiation or the phase of the electromagnetic radiation. The optical modulator may operate according to a change of an electro-refraction or an electro-absorption caused by an electric current or a voltage applied to an optical waveguide through which the light passes, for example, an optical waveguide of a semiconductor material.

An electro-absorption modulator is an opto-electronic device that modulates light intensity by modulating an electric field controlling absorption of the light. Electro-absorption modulators are used for various types of optical signal processing. In particular, the output of a semiconductor laser diode can be modulated more rapidly by an electro-absorption modulator than by modulation of the driving power of the laser diode itself. Electro-absorption modulators can be fabricated from semiconductor materials, enabling a modulator and laser to be integrated into the same semiconductor chip.

In most conventional optical modulators, the characteristics of light are changed with respect to the light of a certain wavelength, and thus, an operation bandwidth of the optical modulators is narrow, that is, about 20 nm or less. In addition, manufacturing a relatively high speed optical modulator due to a resistance-capacitance (RC) delay may be difficult. Furthermore, since a modulation depth per unit length of the optical waveguide is relatively small, a size of the optical modulator may be increased in order to modulate the light sufficiently.

Graphene is a material having a two-dimensional hexagonal carbon structure. Graphene may be used instead of semiconductors and has a carrier mobility of about 200,000 cm2V-1s-1 at room temperature, which is one hundred times higher than that of silicon, and thus, may be used in a higher speed operation device, for example, an optical modulator. However, even using graphene, the small bandwidth and low speed may be still present.

### DESCRIPTION OF THE INVENTION

There is therefore the need of an optical modulator including graphene, and a method to modulate an optical signal, having a relatively wide bandwidth and at the same time having a reasonable speed.

According to a first aspect, the invention relates to a segmented optical modulator, comprising
a waveguide where electromagnetic radiation to be modulated is adapted to travel along a travelling direction;
between 2 and 30 modulating segments, each segment comprising:
a first layer of graphene and a second layer of graphene, a portion of the first layer of graphene overlaying a portion of the second layer of graphene and the first and second layer of graphene overlaying a portion of the waveguide;
a dielectric layer interposed between the first layer of graphene and the second layer of graphene, the dielectric layer having a thickness comprised between 6 nm EOT and 15 nm EOT;
a first metal electrode in contact with the first layer of graphene;
a second metal electrode in contact with the second layer of graphene;
wherein the distance between the first electrode and the second electrode is comprised between 650 nm and 1500 nm;
wherein the length of each segment in the travelling direction is comprised between 10 micrometers and 60 micrometers.

According to a second aspect, the invention relates to a method to modulate an electromagnetic radiation, comprising the steps of:
providing the optical modulator according to the first aspect;
inputting the electromagnetic radiation having a wavelength between 1260 nm and 1625 nm in the waveguide;
driving the segmented modulator with a distributed, segmented electrical driver.

In the following, the terms “above”, “below”, “right”, “left” and additional spatial terminology refer to the position of the modulator during its fabrication. The modulator afterwards can be moved and rotated in any different position. The original frame of coordinates is however used for clarity.

The graphene modulator of the present invention can be used as an electro-absorption modulators (EAM's). In addition, the graphene modulator can be used as an electro-refractive (phase) modulator. In the following, therefore, the term “graphene modulator” encompasses both modulator's types.

The optical modulator is used to modulate an electromagnetic radiation (or signal) travelling in a waveguide. Preferably, the electromagnetic radiation has a wavelength comprised between 1260 nm and 1625 nm. These are the preferred wavelengths for telecommunication. Therefore, it is preferred that the modulator is adapted for those wavelengths. The electromagnetic signal travelling in the waveguide defines a travelling or propagating direction in the waveguide.

Preferably, the waveguide comprises a core and a cladding. Preferably the waveguide core has a thickness comprised between 200 nm and 250 nm.

Preferably, the waveguide is realized in silicon, preferably undoped silicon, or in silicon nitride (SiN). Preferably, the technique of fabrication of the waveguide is according to the standard silicon photonic, where the silicon typically lies on top of a layer of silica in what is known as silicon on insulator (SOI).

The optical modulator of the invention is “segmented”. Segmentation of the graphene modulator is preferable to improve the speed and bandwidth of the modulator, as detailed below.

Each segment of the optical modulator comprises a graphene capacitor as described below. The segments of the optical modulator are comprised between 2 and 30, more preferably between 3 and 12. The segments are in series one after the other and acts on the same waveguide. In other words, the optical modulator comprises a plurality of “pieces” (segments) disposed one after the other along the direction of travelling of the electromagnetic radiation in the waveguide.

The minimum distance between two segments is preferably 1 micrometer.

Each segment of the optical modulator of the present invention is based on a “graphene capacitor”. The graphene capacitor is formed by a first graphene layer and by a second graphene layer which are located one above the other. There is therefore a portion of the first graphene layer and a portion of the second graphene layer that overlay. This defines an overlaying portion, that is, the portion that in a top view of the segment is common to both the first and second graphene layer. In between the two layers, a dielectric or insulator layer is present. This configuration forms a “capacitor”, which has a certain thickness, substantially equal to the thickness of the dielectric layer. Furthermore, the capacitor has a width and a length. The width of the capacitor is defined as the width of the overlaying portion between the first and second graphene layers, measured in a direction perpendicular to the thickness and to the travelling direction of the electromagnetic radiation in the waveguide. Furthermore, the length of the capacitor is defined as the length of the overlaying portion of the first and second graphene layer in a direction parallel to the travelling direction in the waveguide.

Preferably, the first graphene layer and the second graphene layer are parallel to each other. Thus the distance between the first graphene layer and the second graphene layer in the overlaying portion is preferably constant.

The width and the length of the graphene capacitor defines the width and the length of the segment. Therefore, with “length of the segment”, the length of the capacitor is meant, which is the length of the graphene layer along a direction parallel to the travelling direction of the electromagnetic radiation in the waveguide.

The length of the graphene capacitor, and thus of the segment, is comprised between 10 micrometers and 60 micrometers.

The segments can have an equal length to each other, or they may have different lengths. However, the lengths of all segments is within 10 micrometers and 60 micrometers.

The graphene capacitor is formed above the waveguide. Preferably, the first graphene layer is the layer closer to the waveguide, while the second graphene layer is located further away from the waveguide with respect to the first graphene layer. Preferably, the waveguide comprises a core and a cladding. Preferably, the first graphene layer is not in contact with the core of the waveguide. Preferably, the first graphene layer is formed on the cladding of the waveguide.

Preferably, the graphene capacitor overlays the core of the waveguide.

Preferably, the waveguide defines a width, which is defined in the same direction as the width of the graphene capacitor. Preferably, the core of the waveguide defines a width. Preferably, the width of the core of the waveguide is equal to or smaller than the width of the graphene capacitor.

Preferably the width of the capacitor is within the range 300 nm to 1500 nm.

Preferably the width of the core of the waveguide is within the range 300 nm to 700 nm for operating wavelength within the range 1300 nm to 2000 nm, and more preferably within the range 1260 nm to 1625 nm.

As described in more details in the following, the width of the segment is preferably comprised between 650 nm and 1500 nm at 1550 nm operating wavelength.

With the term “graphene layer”, a single atomic layer or a multi-atomic layer of graphene is meant. Each layer of graphene is an atomic-scale hexagonal lattice made of carbon atoms. The number of atomic layers in the present invention included in a graphene layer is comprised between 1 and 3, both for the first and second graphene layer.

The first graphene layer therefore acts as the first capacitor plate and the second graphene layer acts as the second capacitor plate.

The graphene first and second layer are, as said, separated by a dielectric layer. The dielectric layer may comprise a single layer or a plurality of stacked dielectric layers. If more than one layer is present (i.e. the dielectric layer is a multi-layer), the layers may be made of different materials. Further, if the dielectric layer is a multi-layer, the layers may have different thicknesses one from the others.

Preferably, the dielectric layer includes a layer of hexagonal boron nitride (h-BN). Preferably, the layer of h-BN is substantially two dimensional. Preferably, the h-BN layer is in contact with the first or the second graphene layer. Preferably, the dielectric layer includes a first and a second layer of h-BN. Preferably, the first layer of h-BN is in contact with the first graphene layer and the second layer of h-BN is in contact with the second graphene layer. Preferably, the dielectric layer includes a third layer between the first h-BN layer and the second h-BN layer. The h-BN layer is preferably used because “thin” h-BN layers can be very flat, that is, they can form an extremely flat surface where the graphene can be deposited also forming a very uniform layer. It is preferred that the h-BN layer is “thin”, i.e. it is a mono-layer, in order to achieve a better quality and homogeneity of the graphene layer. A “thick” h-BN layer would create undesired roughness. Furthermore, the h-BN layer can encapsulate the graphene layer to protect it from further material depositions.

Materials in which the dielectric layer can be realized are one or more of the following: Al₂O₃, HF₂O₃, SiN, SiO2, h-BN, BN. Preferably, the dielectric layer comprises: a SiN layer and a h-BN layer. Preferably, the h-BN layer is included in-between the graphene layer and the dielectric (Al₂O₃, HF₂O₃, SiN, SiO2, h-BN, BN).

The thickness of the dielectric layer (which is the thickness of a single layer if the dielectric layer includes one layer, or it is equal to the sum of all thicknesses forming the dielectric layer) is defined in terms of the equivalent oxide thickness (EOT). The equivalent oxide thickness is the thickness of an equivalent silicon oxide film connected to the thickness of the dielectric layer used as follows:

$$\\ EOT = {t}_{diel} * ( {k}_{sio 2} / {k}_{diel} )$$

Where t_{diel} is the “real” thickness of the dielectric layer interposed between the two layers of graphene, kₛᵢₒ₂ is the dielectric constant of silicon oxide and k_{diel} is the dielectric constant of the material in which the dielectric layer is formed.

In case of a dielectric multilayer, an average value of the dielectric constant k_{diel} has to be defined.

An equivalent oxide thickness is usually given in nanometers (nm) and it can be seen as the thickness of silicon oxide film that provides the same electrical performance as that of another material, for example a high-k material, being used.

The thickness of the dielectric insulator determines the modulator capacitance which determines both the modulator speed and the modulation efficiency (i.e. the amount of amplitude/phase change in the electromagnetic radiation travelling in the waveguide versus the applied voltage) of each segment of the optical modulator.

Each layer of graphene is in contact with an electrode formed in metal. Therefore, the first graphene layer is in contact with a first electrode and the second graphene layer is in contact with a second electrode. The electrodes first and second are used to apply a potential difference (potential) between the two graphene layers.

Preferably, the first and/or the second electrode are made of one or more of the following metals: Gold, Nickel, Palladium, Aluminium, Copper, Tungsten or alloys thereof. The electrodes may be formed by a single material, that is, a single metal, or by a layered structure of different metals, for instance Nickel in contact with graphene and Gold on top of it. The layered structure is so selected in order to minimize the contact resistance with the graphene layers and to achieve CMOS compatibilities.

Preferably, the distance between the first metal electrode and the second metal electrode is equal to or longer than the width of the overlaying region of the two graphene layers in the graphene capacitor. The distance between the two metal contacts is calculated as the smallest Euclidean distance calculated on a projections of the two contacts on a plane containing the travelling direction.

A voltage is applied between the two electrodes. This voltage includes a DC bias voltage and a signal voltage. The signal voltage applied is called driving voltage. Preferably, the driving voltage applied is comprised between 1 V and 2.5 V.

The purpose of the application of such a potential can be seen with reference to FIG. 1. FIG. 1 shows the effective index (upper line) and optical absorption (lower line) at 1550 nm optical wavelength of a graphene modulator as a function of the graphene chemical potential in the overlapping region of the capacitor. The modulator considered to create this figure is based on an air cladded 220 nm thick silicon with waveguide width 450 nm, graphene overlapping region 650 nm wide, metal contact distance 1500 nm and high quality graphene with mobility >5000 cm²V⁻¹s⁻¹ at 0.4 eV. Changing the graphene chemical potential in the overlapping region, i.e. by applying an external voltage to the metal electrodes, both the effective index and optical absorption change significantly. For EAM applications, the interesting region is where the optical absorption changes rapidly, i.e. when the chemical potential is larger than half of the photon wavelength (Pauli blocking condition) that at 1550 nm corresponds to 0.4 eV. For phase modulation, the interesting region is where the optical absorption is at minimum and nearly constant, e.g. at 1550 nm for chemical potential >0.55 eV.

Preferably, the optical modulator is connected to an electronic driver. Each segment of the modulator is provided with electrodes connected all together to the electronic driver. The electronic driver is a segmented electronic driver and each segment of the modulator is individually connected to the distributed segmented electronic driver defined as an electronic circuit, which splits the driving electrical signals in a number of signals equal to the number of the optical modulator segments. The electronic driver sends the driving voltage to the electrodes and synchronizes the sending of the voltage depending on the position of the segment. For example, the synchronization may be performed using a radio frequency waveguide. The radio frequency waveguide may include electrical delay sections intended to match the velocity of the radio frequency wave and the velocity of the optical wave allowing for synchronous driving of the modulator segments. In a different embodiment, each of the split electrical signals is properly delayed in the electrical domain in order to allow for synchronous driving of the modulator segments.

Without being bound by theory, the dimensions and number of segments claimed in the present invention allow to create an optical modulator which has a wide bandwidth and high efficiency.

The key feature of the individual segment is the reduced size that contributes to achieve a sufficient small capacitance such to allow for a relatively large bandwidth compared to the case of single and extended (non-segmented) electrodes. The segment count constituting each modulation section for each waveguide is determined by the amount of absorption or phase to be achieved with the modulator.

The graphene EAM is characterized by an intrinsic trade-off of performance in terms of modulation efficiency (defined as the maximum change of optical transmission expressed in dB per applied voltage unit) and modulation bandwidth (defined as the high frequency at which the modulation efficiency drops by 3 dB). Similar tradeoff affects the phase modulator in which case the modulation efficiency is defined as the voltage to obtain a pi phase shift times the device length (V_{π}L expressed in V*cm).

Both these features are directly related to the capacitance per unit area (Cₒₓ) of the “graphene capacitor” defined in each segment. Cₒₓ depends from the equivalent oxide thickness (EOT) of the material of the dielectric layer which is interposed between the two layers of graphene.

The modulation efficiency is affected by Cₒₓ since the change in optical absorption is determined by the electrical charge accumulated on the graphene layer, i.e. capacitor plates. Given the relation between the capacitance, the charge and voltage of a parallel plate capacitor, at fixed voltage the larger the capacitance the larger the charge, i.e. the modulation efficiency of the graphene EAM.

The modulator intrinsic bandwidth is determined by the equivalent circuit of the modulator which can be simplified in a simple resistor-capacitor (RC) circuit where the capacitor is the graphene-dielectric-graphene stack, while the resistor is the series resistance arising from two factors: the resistance of the metal to graphene electrical contact, and the resistance of the graphene region from the metal to the capacitor. In a RC circuit the bandwidth (BW) is inversely proportional to the product of the resistance and the capacitor: i.e. in a graphene modulator the larger the capacitance, the lower the modulation bandwidth.

Therefore the desire to have modulation efficiency and large bandwidth are substantially “competing” and requiring opposite characteristics of the modulator. The present invention is to obtain the substantially optimal tradeoff, or compromise, between the two.

Furthermore, the intrinsic modulator bandwidth can be improved by reducing the distance between the electrodes and the graphene capacitor, and by reducing the metal/graphene contact resistance (the metal being the electrodes' material). The contact resistance does not affect significantly other features of the modulator, and the effort should be devoted to reduce it to the lowest possible value, desirably below 200 Ωμm. On the contrary, reducing the distance between the metal contact and the graphene capacitor affects the insertion loss of the optical modulator. With reference to a segment of the modulator, the metal to the capacitor distance may be reduced in two ways: reducing the distance between the electrodes at fixed capacitor width, and/or increasing the capacitor width at fixed metal to metal distance.

Reducing the distance between the electrodes is possible until the evanescent tails of the guided mode of the electromagnetic radiation travelling in the waveguide do not overlap significantly with the electrodes. When the last are too close to the waveguide the metal optical absorption increases causing extra insertion loss. Again a tradeoff occurs in order to allow high bandwidth and low insertion loss. The second approach to reduce the metal to the capacitor distance is to increase the capacitor width at fixed metal distance, which improves the insertion loss at the expense of the modulation bandwidth.

In general a larger width is desirable because it relaxes the alignment tolerances with respect to the waveguide width. Moreover, the graphene of the lead regions is not gated during operation, in fact the surface carrier concentration is changed only in the capacitor overlapping region, with the gating effect reducing rapidly in the adjacent regions (not overlapping) within a hundred nm. Thus, the graphene leads should be assumed to be at the maximum of the optical absorption (typical values of the graphene doping as transferred are ≤0.2 eV) introducing insertion losses. As a consequence, if the contact resistance is low (for example about 200 Ωμm) it is desirable to set the capacitor width close to the metal distance in order to increase the intrinsic modulator bandwidth and reduce the insertion loss.

Therefore substantially the distance between the two electrodes is about equal to the width of the graphene capacitor.

However, the modulation efficiency and insertion loss come to a tradeoff as well.

The above considerations apply to a phase modulator as well.

The applicant has therefore found the best configuration of the optical modulator in order to guarantee a bandwidth of at least 70 GHz and an extinction ration at least of 6 dB. In the present application, the term “bandwidth” indicates the highest frequency at which the modulation efficiency drops by 3 dB.

### BRIEF DESCRIPTION OF THE DRAWINGS

The present invention will be described now in detail with no limiting reference to the appended figures, where:

FIG. 1 is a graph showing the effective index (upper line) and propagation loss (lower line) of a graphene modulator based on the cross section shown in FIG. 2. Waveguide width 450 nm, waveguide height 220 nm, graphene overlapping region 650 nm wide, metal contact distance 1500 nm. Graphene mobility at 0.4 eV>5000 cm²V⁻¹s⁻¹, graphene chemical potential in the not overlapping region 0.2 eV;

FIG. 2 is a cross section of an optical modulator realized according to the invention;

FIG. 3 is a schematic top view of the optical modulator of FIG. 2;

FIG. 4 is a cross section of a Mach Zehnder modulator using the modulator of the present invention;

FIG. 5 is a top view of the Mach Zehnder modulator of FIG. 4;

FIG. 6 is a graph showing the modulation efficiency per unit length (continuous line) and intrinsic modulation bandwidth (dashed lines) versus EOT, i.e. calculated from the simplified RC circuit where the capacitor is the graphene-dielectric-graphene stack, and the resistor is the series resistance arising from the resistance of the metal to graphene electrical contact, and the resistance of the graphene region from the metal to the capacitor. All the curves calculated at capacitor width 0.65 μm, while intrinsic bandwidth is calculated with metal distance 1.5 μm (upper dashed line) and 0.85 μm (lower dashed line);

FIG. 7 is a graph showing the insertion loss per unit length versus metal distance and intrinsic modulation bandwidth (dashed lines) versus EOT. It is considered an air cladded silicon waveguide 450 nm×220 nm at 1550 nm, assuming transparent graphene (chemical potential >0.6 eV at 1550 nm), while intrinsic bandwidth is calculated with contact resistance 100 Ωμm (upper solid line) and 500 Ωμm (lower solid line);

FIG. 8 is a graph showing the modulator insertion loss per unit length versus capacitor width for a fixed metal distance of 1.5 μm (a) and 0.85 μm (b);

FIG. 9 and FIG. 10 are two graphs showing the extinction ratio per unit length and unit voltage (dashed lines), and the insertion loss per unit length (solid lines) as a function of the chemical potential of the graphene layer in the capacitor region (a). Figure of merit per unit voltage, extinction ratio divided by the insertion loss, as a function of the chemical potential of the graphene layer in the capacitor region. Metal distance 1.5 μm, graphene capacitor width 650 nm;

FIG. 11 is a graph showing V_{π}L as a function of the graphene chemical potential in the capacitor region. Graphene capacitor width 650 nm;

FIG. 12 is a graph showing FOM calculated as VπL*IL as a function of the graphene chemical potential in the capacitor region. Graphene capacitor width 650 nm. Dashed lines are related to a metal distance of 850 nm, solid lines to a metal distance of 1.5 μm.

### PREFERRED EMBODIMENTS OF THE INVENTION

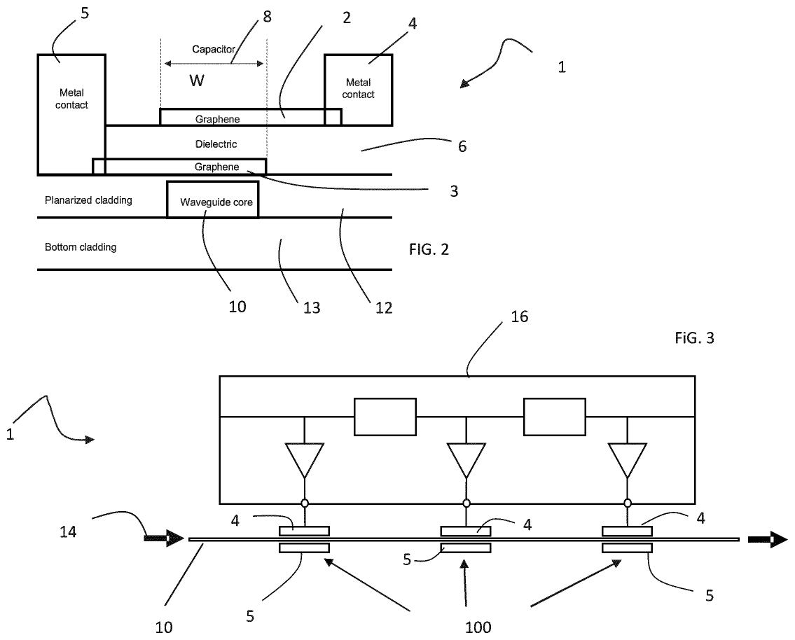

With initial reference to FIGS. 2 and 3, an optical modulator realized according to the present invention is globally indicated with 1.

The optical modulator includes between 2 and 30 segments 100, more preferably between 3 and 12 segments 100. In FIG. 2, the cross section of a single segment 100 is shown. The optical modulator 1 includes a first graphene layer 2 and a second graphene layer 3. The first and second graphene layers 2, 3 form a capacitor. Respective side surfaces of the first graphene layer and the second graphene layer are separate from each other.

The optical modulator 1 further comprises a first electrode 4 in contact with the first graphene layer 2, and a second electrode 5 in contact with the second graphene layer 3.

The optical modulator 1 further includes a dielectric layer 6 located between the first graphene layer 2 and the second graphene layer 3. The dielectric layer may have a thickness between 6 nm EOT and 15 nm EOT. The thickness of the dielectric layer 6 is equal to the distance between the first graphene layer and the second graphene layer.

The first graphene layer 2 and the second graphene layer 3 defines an overlapping region 8 having width W and length L.

The optical modulator further includes a waveguide. The waveguide includes a waveguide core 10 and a waveguide cladding 11. In turn, the waveguide cladding may include a first (upper) cladding 12 and a second (bottom) cladding, 13. Preferably, the cladding is realized on a substrate or the same bottom cladding is the substrate. Preferably, a passive waveguide platform, i.e., pure dielectric waveguides, without implantation or epitaxy processes, are used. Preferably, the waveguide has a silicon core.

In the waveguide, preferably an electromagnetic radiation is adapted to travel. In FIG. 3 (and in the subsequent figures), the electromagnetic radiation is indicated by an arrow 14. The optical modulator is adapted to modify the electromagnetic signal travelling in the waveguide.

Preferably, the first graphene layer 2 and the second graphene layer 3 may be formed on a center portion of the core 10 of the optical waveguide. Preferably, the overlapping portion 8 is located above the waveguide core 10. The first graphene layer and the second graphene layer preferably are planar and parallel to each other. Preferably, they define plane structures parallel to a surface of the substrate.

The waveguide to be used in the present invention may for example be a waveguide contained in a wafer in a standard SOI photonics.

The electrodes 4, 5 of each segment are connected to an electronic driver 16. The electronic driver is responsible for sending a suitable potential to the electrodes of each segment and in addition to synchronize the application of such potential with the travelling electromagnetic radiation inside the waveguide. Different driving schemes may be possible. For example, a driving scheme as described in U.S. Pat. No. 10,120,210 can be used.

Preferably the first upper cladding 12 is as planar as possible in the area where the first graphene layer is deposited. Preferably, the first graphene layer is created according to any known technique and is located above the core 10 of the waveguide. Preferably, the first graphene layer 2 is encapsulated by a layer of h-NB to protect the graphene from the subsequent deposition of the dielectric layer 6. In some embodiments, the graphene is grown using a CVD process and then transferred onto the cladding of the waveguide e.g., using a wet transfer process. In some embodiments, the first graphene layer comprises or consists of a single layer of carbon atoms.

The first electrode 4 is deposited on a portion of the first graphene layer 2. In some embodiments, the first electrode 4 comprises a metal. In some embodiments, the first electrode is deposited using ALD, CVD, or PVD. For example, the first electrode may be deposited using electron-beam (e-beam) evaporation.

Preferably the dielectric material forming the dielectric layer may be deposited using a number of different techniques. In some embodiments, the dielectric material is deposited using atomic layer deposition (ALD), chemical vapor deposition (CVD), or physical vapor deposition (PVD).

The dielectric material of the dielectric layer 6 is deposited on the first graphene layer.

The second graphene layer is deposited on the first electrically insulating material. The second graphene layer may be deposited on the first electrically insulating material using a similar or the same process described with respect to the first graphene layer. In some embodiments, the second graphene layer comprises or consists of a single layer of carbon atoms. Furthermore, before the deposition of the second layer of graphene, a second layer of h-BN can be deposited in order to flatten the surface of the dielectric layer.

Further, the second electrode 5 is deposited on a portion of the second graphene layer 3. The second electrode may be deposited using a similar or the same process with respect to the first electrode.

Details on how to fabricate a single segment 100 of the optical modulator 1 can be found for example in the following article:

### Wafer-Scale Integration of Graphene-Based Photonic Devices

Marco A. Giambra, Vaidotas Mišeikis, Sergio Pezzini, Simone Marconi, Alberto Montanaro, Filippo Fabbri, Vito Sorianello, Andrea C. Ferrari, Camilla Coletti,and Marco Romagnoli.

Which can be found in

https://pubs.acs.org/action/showCitFormats?doi=10.1021%2Facsnano.0c09758&ref=pdf&

The double layer graphene modulator described above can modulate the radiation travelling in the waveguide. The modulator of the invention can modulate light of different wavelengths.

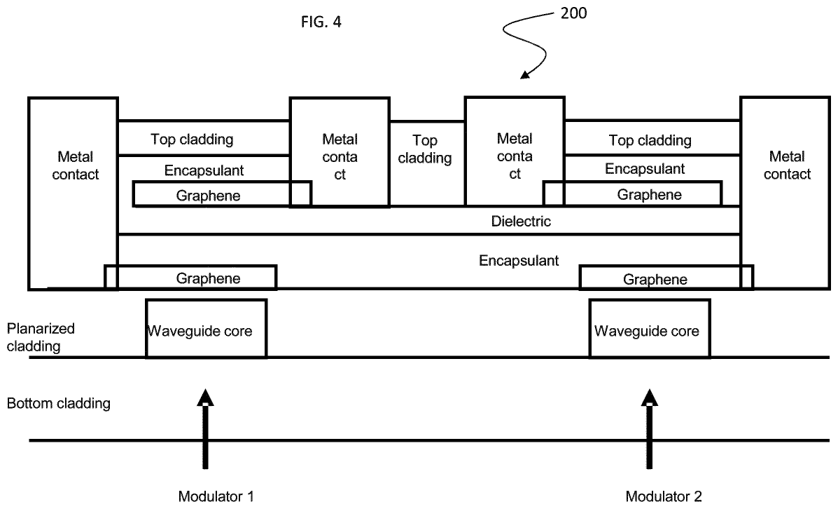

Further, the modulator 1 of the invention can be used alone or in combination with other modulators. For example, in FIGS. 4 and 5, a Mach Zehnder modulator 200 is depicted. In the Mach Zehnder 200, two waveguides 10, 10′ are present. For each of these waveguides, a modulator like the modulator 1 above described is used to modulate the light. Preferably, one of the two graphene layers of one modulator has an electrode in common with one of the two graphene layers of the other modulator.

### EXAMPLES

The response of the optical modulator has been simulated using a commercial software such as:

https://www.lumerical.com/products/

and have been made under the following assumption.

Being a 2D material, Graphene optical properties are properly modeled through its surface conductivity at optical frequencies σ(ω, μ_{c}, Γ,T), where ω is the radian frequency, μ_{c} is the chemical potential, Γ is a phenomenological scattering rate taking into account electron-disorder scattering processes, and T is the temperature. In the following, a simplified scattering rate model with constant Γ independent on the energy E is considered. Under this approximation, the surface conductivity can be expressed through the Kubo Formula

$$\\ \begin{matrix}σ ( ω , {μ}_{c} , Γ , T ) = \frac{{ie}^{{}_{} 2} ( ω + i 2 Γ )}{π {}_{} {ℏ}^{{}_{} 2}} [ \frac{1}{{( ω + i 2 Γ )}^{2}} {\int }_{0}^{∞} E ( \frac{\partial {f}_{d} ( E )}{\partial E} - \frac{\partial {f}_{d} ( - E )}{\partial E} ) \partial E -- {\int }_{0}^{∞} \frac{{f}_{d} ( - E ) - {f}_{d} ( E )}{{( ω + i 2 Γ )}^{2} - 4 {( E / ℏ )}^{2}} \partial E ] , & ( 1 )\end{matrix}$$

where e is the electron charge, ℏ is the reduced Planck constant, E the energy, and f_{d}(E) is the Fermi-Dirac distribution:

$$\\ {f}_{d} ( E ) = \frac{1}{( {e}^{{}_{} \frac{E - {μ}_{c}}{{k}_{B} T}} + 1 )} ,$$

where k_{B} is the Boltzmann's constant. The first term in (1) is the contribution arising from intra-band electron-photon scattering processes, while the second is due to inter-band electron-photon scattering. The chemical potential μ_{c} is determined by the carrier density nₛ on the Graphene layer through

$$\\ {n}_{s} = \frac{2}{π {}_{} {ℏ}^{{}_{} 2} {v}_{F}^{{}_{} 2}} {\int }_{0}^{∞} E ( {f}_{d} ( E ) - {f}_{d} ( E + 2 {μ}_{c} ) ) \partial E ,$$

where v_{F}≈9.5·10⁵ m/s is the Fermi velocity. Because of the pronounced field effect in Graphene, the carrier density can be easily controlled by application of a gate voltage and/or chemical doping, leading to a consequent significant tunability of the surface conductivity.

Further, it has been set that

Target bandwidth BW (−3 dB)≥70 GHz

Target ER≥6 dB

The distance between the electrodes has been set equal to the width of the capacitor, that is, the width of the overlap of the first and second layer of graphene.

In each simulation, a value of the impedance Z_{d} of the electronic driver driving the electrodes (i.e. applying a potential to the electrodes) has been selected. In the simulations, the selection of the impedance is such that 25Ω≤Z_{d}≤50Ω. These are typical values of standard electronic drivers and therefore no special control of the electrodes is needed.

Furthermore, also the contact resistance between the graphene layers and the electrodes has been selected and fed as an input in the simulations.

Further, the voltage applied V_{d} is within the voltage that electronic drivers can generally apply (in the simulations, values between 1 Vₚₚ and 1.5 Vₚₚ have been used, which are standard voltages).

The modulator is based on an air cladded 220 nm thick silicon waveguide with waveguide width of 450 nm.

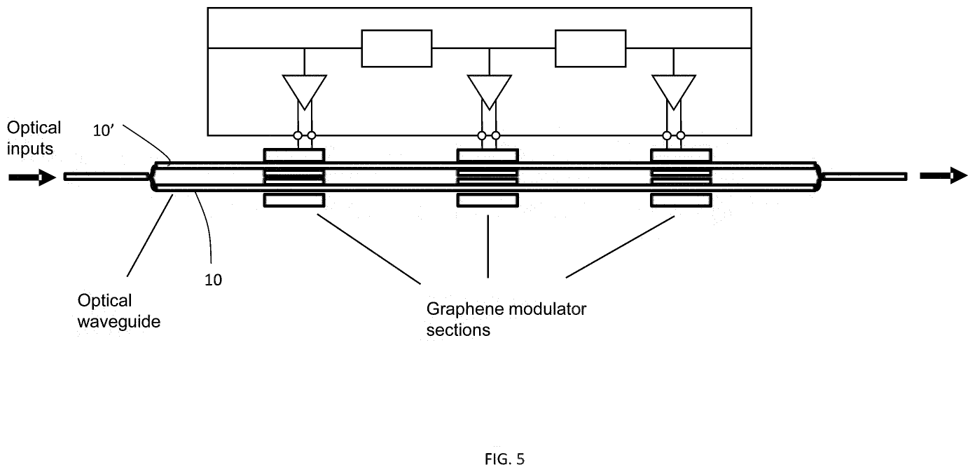

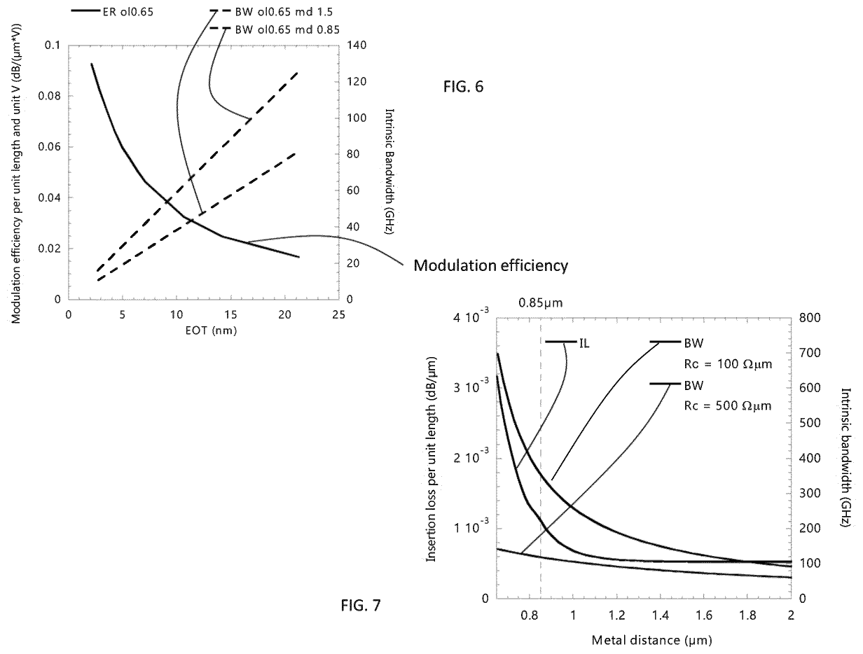

FIG. 6 shows the extracted modulation efficiency per unit length (red lines) as a function of the capacitor EOT, i.e. maximum extinction ratio obtained with 1V for a graphene EAM based on an air cladded 220 nm thick silicon with waveguide width 450 nm, operating at 1550 nm optical wavelength and biased so that the chemical potential on the graphene layers is set to 0.4 eV. In all the following plots high quality graphene with mobility>5000 cm²V⁻¹s⁻¹ at 0.4 eV is assumed. In FIG. 6, also the intrinsic (i.e. not including the driver impedance) modulation bandwidth (dashed lines) are shown with different distances among the electrodes.

The intrinsic modulation bandwidth is calculated as: (2*π*(2*R_{c}/L+Rₛₕ*W_{lead}/L)*Cₒₓ*Wₒₗ*L)⁻¹, where R_{c} is the metal (of the electrodes) to graphene contact resistance expressed in Ωμm, L is the optical modulator length, Rₛₕ the graphene sheet resistance in the region between the capacitor and electrodes expressed in Ωsq, W_{lead} is the width of the region between the capacitor and electrodes, Wₒₗ the width of the graphene overlapping region, i.e. capacitor width. According to the formula the modulator intrinsic bandwidth does not change with the length of the device as the resistance scales inversely with the device length while the capacitor scales linearly.

The curves of FIG. 6 are calculated assuming the following parameters: capacitor width (Wₒₗ) 0.65 μm, metal to metal distance (md=W_{lead}+Wₒₗ) of 1.5 μm and capacitor width of 0.55 μm (blue lines), contact resistance of 5000 μm (R_{c}) and sheet resistance of 1 kΩsq (Rₛₕ). While the modulation efficiency is not affected by the metal to metal distance, the intrinsic bandwidth changes because of the resistance of the graphene leads.

FIG. 6 shows clearly the tradeoff between the two key performances of the EAM. In order to improve the modulation efficiency, the EOT should be minimized at the cost of a reduced bandwidth and vice versa.

As said, the intrinsic modulator bandwidth can be improved by reducing the distance between the metal contacts and the graphene capacitor, and by reducing the metal/graphene contact resistance.

Reducing the metal distance is possible until the evanescent tails of the guided mode do not overlap significantly with metals. When the last are too close to the waveguide the metal optical absorption increases causing extra insertion loss. Again a tradeoff occurs in order to allow high bandwidth and low insertion loss. FIG. 7 shows the optical insertion loss per unit length (uppermost line) and intrinsic bandwidth of the graphene EAM of FIG. 6 as a function of the electrodes distance for two different values of the contact resistance: 100 Ωμm (middle line) and 500 Ωμm (lowermost line). Full transparent graphene (chemical potential>0.6 eV at 1550 nm) has been assumed both in the capacitor region and lead regions, graphene sheet resistance of 1 kΩsq and graphene overlap of 0.65 μm.

In the example, the insertion loss is almost constant to a minimum value at 1.5 um and doubles when the metal distance is reduced to 0.85 μm. The bandwidth in general improves when the metal distance is reduced, the effect is more pronounced when the contact resistance is low (>2× improvement from 1.5 um to 0.85 um for contact resistance of 100 Ωμm, 1.5× for 500 Ωμm in the same range). This general behavior depends on the waveguide geometry and material and the evaluation of the optimal metal distance should be determined case by case. The general rule may be to reduce the metal distance to the threshold where the insertion loss increases rapidly, in the example 0.85 μm (dashed line) is a good threshold, values below the threshold should be verified evaluating the modulator insertion loss, including the loss of the graphene leads from the capacitor to the metal, and the extinction ratio.

The second approach to reduce the metal to the capacitor distance is to increase the capacitor width at fixed metal distance, which improves the insertion loss at the expense of the modulation bandwidth. Simulations have been made to show the intrinsic modulation bandwidth of the modulator FIG. 6, for a metal distance of 1.5 μm and 0.850 Ωμm, as a function of the contact resistance (between 50 and 500 Ωμm) and capacitor width (between the waveguide width, 0.45 μm, and the metal distance).

The simulations show that when the contact resistance is large the bandwidth decrease with the capacitor width. This is because the overall resistance is dominated by the contact regions. At low contact resistance the overall resistance is more dependent on the resistance of the lead regions causing an improvement of the bandwidth when the capacitor width approaches the metal distance. At intermediate values of the contact resistance we observe that the bandwidth has a minimum and improves at smaller and larger capacitor width. In the example, the sheet resistance of the leads is assumed 1 kΩsq which is a typical value, the behavior does not change for sheet resistance below 1 kΩsq. For large sheet resistance (>3 kΩsq) the bandwidth is always improving when the capacitor width approaches the metal distance, because the overall resistance is dominated by the lead regions.

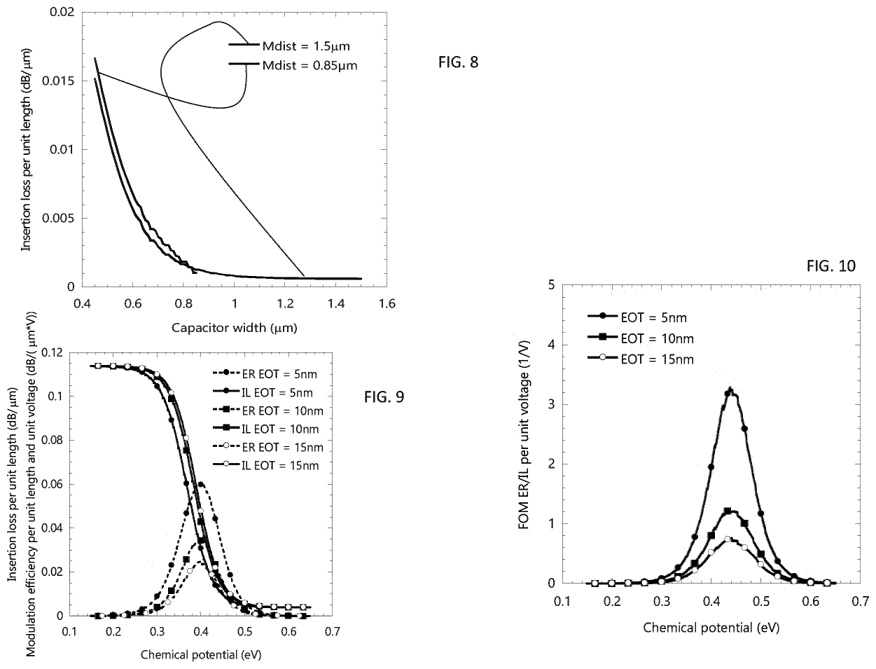

In general a larger width is desirable because it relaxes the alignment tolerances with respect to the waveguide width. Moreover, the graphene of the lead regions is not gated during operation, in fact the surface carrier concentration is changed only in the capacitor overlapping region, with the gating effect reduces rapidly in the adjacent regions (not overlapping) within a hundred nm. Thus, the graphene leads should be assumed to be at the maximum of the optical absorption (typical values of the graphene doping as transferred are ≤0.2 eV) introducing insertion losses. As a consequence, if the contact resistance is low (200 Ωμm) it is desirable to set the capacitor width close to the metal distance in order to increase the intrinsic modulator bandwidth and reduce the insertion loss. FIG. 8 shows the modulator insertion loss per unit length as a function of the capacitor width for fixed metal distance of 1.5 μm and 0.85 μm. The curves are evaluated assuming the graphene capacitor in the transparency regime (chemical potential>0.6 eV at 1550 nm), and graphene leads in the absorption regime (chemical potential<0.2 eV at 1550 nm).

The intrinsic modulator bandwidth has been considered so far, i.e. without taking into account the output resistance of the electrical driver that sums up to the overall resistive contribution. The driver output impedance is typically 50Ω and it is independent on the modulator length. As the device resistance decreases with the inverse of the modulator length, the driver impedance set a limit to the extrinsic modulation bandwidth for long devices.

For these reasons co-design of driver electronics and modulator geometry is desirable in order to optimize the extrinsic modulation bandwidth. Indeed, the last is also affected by the impedance matching between the driver and the modulator.

So far, the intrinsic tradeoff between modulation bandwidth, modulation efficiency and insertion loss has been shown. The extinction ratio has been evaluated by assuming that the graphene capacitor was set to an operating point were the graphene is gated at 0.4 eV at 1550 nm, corresponding to the point of maximum modulation efficiency. The insertion loss due to metal and ungated graphene assuming transparent graphene in the gated region (chemical potential>0.6 eV at 1550 nm) has been discussed. However, the modulation efficiency and insertion loss come to a tradeoff as well. FIGS. 9 and 10 shows the modulation efficiency, in terms of extinction ratio per unit length and unit voltage (dashed lines), and the insertion loss per unit length (solid lines) as a function of the chemical potential of the graphene layer in the capacitor region (FIG. 9). Assuming 1V swing across the operating point, the insertion loss is defined as the absorption at the chemical potential corresponding to Vₒₚ+0.5V. The same modulator of the curve in FIG. 6 with electrodes distance of 1.5 μm and capacitor width of 650 nm has been considered, and three different gating dielectric EOT: 5 nm, 10 nm and 15 nm. The two features can be combined to define a figure of merit (FOM) per unit voltage as the ratio of the modulation efficiency and insertion loss which is reported in FIG. 10.

As shown in FIG. 10, although the maximum of the modulation efficiency is at 0.4 eV, the maximum of the FOM is shifted towards higher chemical potentials. In the example at 1550 nm wavelength the maximum is at 0.44 eV. Increasing the EOT the FOM reduces according to the behavior shown in FIG. 6.

Given the general considerations discussed above, some specifications to be matched are set. It is desired to have an optical modulator which has a minimum ERₘᵢₙ=6 dB, and a minimum bandwidth BWₘᵢₙ=70 GHz. These specifications are met according to the invention by adopting a segmented driving scheme, where “short” modulator sections are driven by dedicated driver with fixed impedance. In fact, according to FIG. 9, matching the ERₘᵢₙ need at least 100 μm device at 0.4 eV with 1 V driving voltage with a gate dielectric of 5 nm EOT, assuming an electrode distance of 1.5 μm and capacitor width of 650 nm. However, assuming a contact resistance of 200 Ωμm, a graphene layer resistance of 1 kΩsq and a driver impedance of 25Ω, the expected modulator bandwidth is only 9.4 GHz. Segmenting the modulator into 10 μm long sections would rise the bandwidth to 23 GHz. Setting the operating point to the maximum of the FOM, at 0.44 eV in the example, the ER per unit length and unit voltage at 15 nm EOT reduces to 0.14 dB/(μm*V), meaning 43×10 μm long sections to achieve ERₘᵢₙ with a FOM of 0.76, i.e. 7.7 dB insertion loss (IL). In this conditions, each 10 μm long segment driven with a 25Ω driver may reach 70 GHz bandwidth. In order to improve the FOM and reduce the number of sections, the driving voltage may be increased to 1.5 V. In this case, the ERₘᵢₙ is achieved with 30×10 μm long sections, the FOM improves to 1.25 corresponding to a total insertion loss of 4.8 dB. The overall performance of the device improve, however the thicker EOT increases the required bias voltage from 4.17 V to 10.76 V.

Further improvement may be obtained by reducing the resistance of the device as discussed previously. For example, reducing the metal distance to 850 nm and 650 nm, assuming a contact resistance of 200 Ωμm, a graphene sheet resistance of 1 kΩsq and a driver impedance of 25Ω, the bandwidth is significantly improved. A modulator segment having a length of 30 μm gives rise to a 78 GHz bandwidth, ER of 0.6 dB and IL of 0.5 dB when the EOT is 15 nm and the driving voltage 1.5 V. In this case 10 sections will be enough to reach the ERₘᵢₙ with an overall IL of 5 dB.

As a conclusion, high performing optical modulator are segmented and driven by a distributed segmented driver whose number of elements depends on the device modulation efficiency, the optimum being between 3 and 30. Graphene contacts preferably exhibits a low contact resistance<200 Ωμm. The optical modulator geometry is realized with a short distance between metal, preferably between 650 nm and 1500 nm, and full graphene overlap capacitor. In this way, a higher bandwidth with a lower number of segments is obtained.

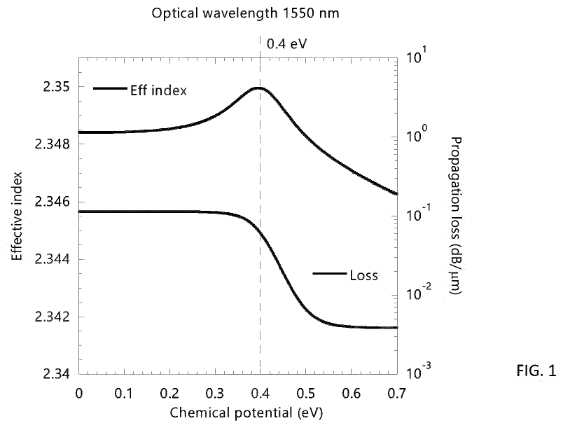

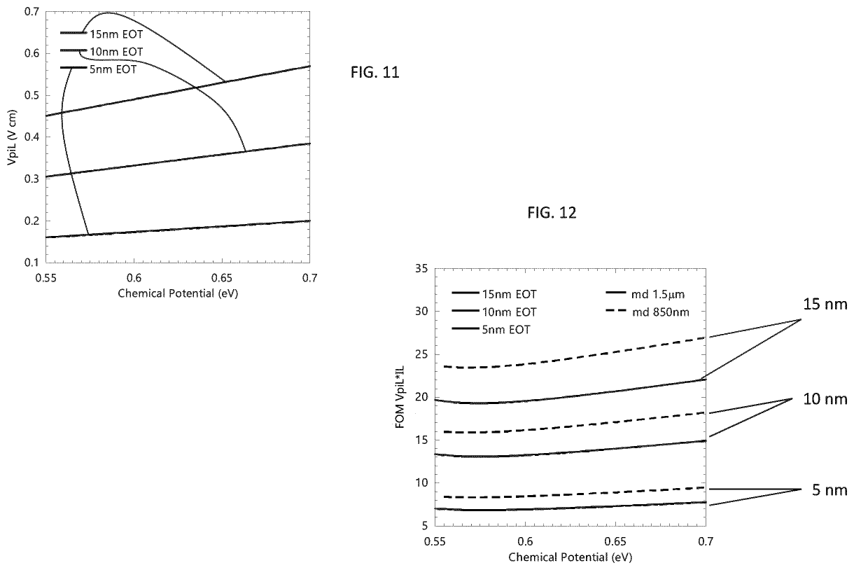

Similar considerations apply to phase modulators. By increasing the dielectric EOT, i.e. reducing the Cox, the modulator bandwidth increases at the expense of the modulation efficiency expressed in terms of VAL. FIG. 11 shows the V_{π}L at 1550 nm wavelength of a graphene modulator based on the cross section of FIG. 1 with air cladding, silicon waveguide 220 nm×450 nm, capacitor width 650 nm, and different EOT: 5 nm (bottom line), 10 nm (middle line), 15 nm (top line).

In this case the objective is to minimize the V_{π}L, i.e. more efficient devices exhibit lower V_{π}L. FIG. 11 shows that the phase modulator efficiency scales almost linearly with the Cₒₓ, larger capacitors allow better efficiency. However, the only V_{π}L does not help in defining the overall phase modulator performance as the propagation loss may affect significantly affect the evaluation on the effectiveness of the device. For this reason it is often made reference to a figure of merit (FOM) defined as the product of the V_{π}L and the propagation loss, i.e. insertion loss per unit length. The phase modulator FOM is strongly affected by the metal distance and graphene quality. The first has been discussed previously, i.e. reducing the metal distance may cause higher propagation losses because of the metal optical absorption. Graphene quality has not been discussed before. The last determines the optical absorption due to intraband scattering in graphene which is highly affected by material imperfections like grain boundaries in polycrystalline films, wrinkles of the transferred material, chemical contamination, etc. In order to have negligible contribution to the propagation loss, transferred graphene mobility should be as high as possible, desirably >5000 cm²V⁻¹s⁻¹ at 0.4 eV. FIG. 12 shows the phase modulator FOM as a function of the chemical potential for a capacitor width of 650 nm and metal distance of 1.5 μm (solid lines) and 850 nm (dashed lines) for different values of the EOT: 5 nm (bottom lines), 10 nm (middle lines), 15 nm (top lines).

Contrarily to EAMs, the best phase modulator is the one with the minimum FOM. From FIG. 9 we see that reducing the metal distance the FOM increases because of the increased propagation loss due to the interaction of the waveguide mode field with metals.

From a bandwidth point of view, the performance of phase modulators follows exactly the behavior described for the EAMs because the device is actually the same but biased to a different point.

Assuming the bandwidth specifications set for the EAMs, a minimum EOT of 15 nm is assumed. Assuming a bias chemical potential of 0.6 eV, i.e. where the absorption is at minimum and nearly constant (see FIG. 2), the required bias voltage is about 19.6V and the V_{π}L 0.5 Vcm (capacitor width 650 nm). Assuming 1.5V driving voltage and a minimum phase shift of pi/4, the expected phase modulator length is about 760 μm. Although the propagation loss increases when the metal distance reduces, the insertion loss of the 760 μm long device does not increase significantly, i.e. about 3 dB for the 1.5 μm metal distance and about 3.7 dB for the 850 nm metal distance. Because of the large length of the device, high bandwidth may be reached only with a segmented driving scheme with segment length which depends on the device cross section exactly as estimated for the EAMs. Assuming those considerations, in the case of a metal distance of 1.5 μm the segment length to achieve 70 GHz is 10 μm while in the case of a metal distance of 850 nm the segment length can be increased to 30 μm, leading to a number of segments of 76 and 25 respectively. Because of the large number of segments, a possible alternative implementation is the use of travelling wave electrodes loaded with the device segments.

### Example 1

Given the input parameters of:
Distance between the electrodes=width of capacitor=0.65 μm
ER=6 dB
BW_{-3 dB}=70 GHz
Z_{d}=50Ω,
V_{d}=1 Vₚₚ
Bias 0.44 eV (max FOM)
R_{c}=50 Ωμm
The above can be obtained with:
   17 segments having a length of 10 μm if the thickness of the dielectric layer is tₒₓ=6 nm EOT. FOM=2.089 (insertion loss−IL˜3 dB).
   14 segments having a length of 28 μm if the thickness of the dielectric layer is tₒₓ=15 nm EOT. FOM=0.6723 (IL˜9 dB)

### Example 2

Given the input parameters of:
Distance between the electrodes=width of capacitor=0.65 μm
ER=6 dB
BW_{-3 dB}=70 GHz
Z_{d}=50Ω,
V_{d}=1 Vₚₚ
Bias 0.44 eV (max FOM)
R_{c}=200 Ωμm
   24 segments having a length of 10 μm with tₒₓ=9 nm EOT. FOM=1.242 (IL˜4.8 dB)
   18 segments having a length of 22 μm if the thickness of the dielectric layer is tₒₓ=15 nm EOT. FOM=0.6723 (IL˜9 dB)

### Example 3

Given the input parameters of:
Distance between the electrodes=width of capacitor=0.65 μm
ER=6 dB
BW_{-3 dB}=70 GHz
Z_{d}=50Ω,
V_{d}=1 Vₚₚ
Bias 0.4 eV (max ER)
R_{c}=50 Ωμm
The above can be obtained with:
   10 segments having a length of 10 μm if the thickness of the dielectric layer is tₒₓ=6 nm EOT. FOM=1.432 (IL˜4.2 dB)
   8 segments having a length of 28 μm if the thickness of the dielectric layer is tₒₓ=15 nm EOT. FOM=0.5021 (IL˜12 dB)

### Example 4

Given the input parameters of:
Distance between the electrodes=width of capacitor=0.65 μm
ER=6 dB
BW₋₃ dB=70 GHz
Z_{d}=50Ω,
V_{d}=1 Vₚₚ
Bias 0.4 eV (max ER)
R_{c}=200 Ωμm
   14 segments having a length of 10 μm if the thickness of the dielectric layer is tₒₓ=9 nm EOT. FOM=0.8574 (IL˜7 dB)
   10 segments having a length of 22 μm if the thickness of the dielectric layer is tₒₓ=15 nm EOT. FOM=0.5021 (IL˜12 dB)

### Example 5

Given the input parameters of:
Distance between the electrodes=width of capacitor=0.65 μm
ER=6 dB
BW_{-3 dB}=70 GHz
Z_{d}=50Ω,
V_{d}=1.5 Vₚₚ
Bias 0.44 eV (max FOM)
R_{c}=50 Ωμm
The above can be obtained with:
   12 segments having a length of 10 μm if the thickness of the dielectric layer is tₒₓ=6 nm EOT. FOM=3.97 (IL˜1.5 dB)
   10 segments having a length of 28 μm if the thickness of the dielectric layer is tₒₓ=15 nm EOT. FOM=1.098 (IL˜6 dB)

### Example 6

Given the input parameters of:
Distance between the electrodes=width of capacitor=0.65 μm
ER=6 dB
BW_{-3 dB}=70 GHz
Z_{d}=50Ω,
V_{d}=1.5 Vₚₚ
Bias 0.44 eV (max FOM)
R_{c}=200 Ωμm
The above can be obtained with:
   16 segments having a length of 10 μm if the thickness of the dielectric layer is tₒₓ=9 nm EOT. FOM=2.218 (IL˜2.7 dB).
   12 segments having a length of 22 μm if the thickness of the dielectric layer is tₒₓ=15 nm EOT. FOM=1.098 (IL˜6 dB)

### Example 7

Given the input parameters of:
Distance between the electrodes=width of capacitor=0.65 μm
ER=6 dB
BW_{-3 dB}=70 GHz
Z_{d}=50Ω,
V_{d}=1.5 Vₚₚ
Bias 0.4 eV (max ER)
R_{c}=50 Ωμm
The above can be obtained with:
   8 segments having a length of 10 μm if the thickness of the dielectric layer is tₒₓ=6 nm EOT. FOM=2.675 (IL˜2.2 dB)
   6 segments having a length of 28 μm if the thickness of the dielectric layer is tₒₓ=15 nm EOT. FOM=0.7972 (IL˜7.5 dB)

### Example 8

Given the input parameters of:
Distance between the electrodes=width of capacitor=0.65 μm
ER=6 dB
BW−3 dB=70 GHz
Zd=50Ω,
Vd=1.5 Vpp
Bias0.4 eV (max ER)
Rc=200 Ωμm
The above can be obtained with:
   10 segments having a length of 10 μm if the thickness of the dielectric layer is tₒₓ=9 nm EOT. FOM=1.51 (IL˜4 dB)
   7 segments having a length of 22 μm if the thickness of the dielectric layer is tₒₓ=15 nm EOT. FOM=0.7972 (IL˜7.5 dB)

### Example 9

Given the input parameters of:
Distance between the electrodes=width of capacitor=0.65 μm
ER=6 dB
BW−3 dB=70 GHz
Zd=25Ω,
Vd=1 Vpp
Bias 0.44 eV (max FOM)
Rc=50 Ωμm
The above can be obtained with:
   9 segments having a length of 20 μm if the thickness of the dielectric layer is tₒₓ=6 nm EOT. FOM=2.089 (IL˜3 dB)
   7 segments having a length of 56 μm if the thickness of the dielectric layer is tₒₓ=15 nm EOT. FOM=0.6723 (IL˜9 dB)

### Example 10

Given the input parameters of:
Distance between the electrodes=width of capacitor=0.65 μm
ER=6 dB
BW−3 dB=70 GHz
Zd=25Ω,
Vd=1 Vpp
Bias 0.44 eV (max FOM)
Rc=200 Ωμm
The above can be obtained with:
   12 segments having a length of 20 μm if the thickness of the dielectric layer is tₒₓ=9 nm EOT. FOM=1.242 (IL˜4.8 dB)
   9 segments having a length of 44 μm if the thickness of the dielectric layer is tₒₓ=15 nm EOT. FOM=0.6723 (IL˜9 dB)
Bias 0.4 eV (max ER)
R_{c}=50 Ωμm
   10 segments having a length of 10 μm if the thickness of the dielectric layer is tₒₓ=6 nm EOT. FOM=1.432 (IL˜4.2 dB).
   8 segments having a length of 28 μm if the thickness of the dielectric layer is tₒₓ=15 nm EOT. FOM=0.5021 (IL˜12 dB)
R_{c}=200 Ωμm.
   14 segments having a length of 10 μm if the thickness of the dielectric layer is tₒₓ=9 nm EOT. FOM=0.8574 (IL˜7 dB).
   10 segments having a length of 22 μm if the thickness of the dielectric layer is tₒₓ=15 nm EOT. FOM=0.5021 (IL˜12 dB)
ER=6 dB, BW₋₃ dB=70 GHZ, Z_{d}=25Ω, V_{d}=1.5 Vₚₚ
Bias 0.44 eV (max FOM)
R_{c}=50 Ωμm.
   6 segments having a length of 20 μm if the thickness of the dielectric layer is tₒₓ=6 nm EOT. FOM=3.97 (IL˜1.5 dB).
   5 segments having a length of 56 μm if the thickness of the dielectric layer is tₒₓ=15 nm EOT. FOM=1.098 (IL˜6 dB)
R_{c}=200 Ωμm.
   8 segments having a length of 20 μm if the thickness of the dielectric layer is tₒₓ=9 nm EOT. FOM=2.218 (IL˜2.7 dB).
   6 segments having a length of 44 μm if the thickness of the dielectric layer is tₒₓ=15 nm EOT. FOM=1.098 (IL˜6 dB)
Bias 0.4 eV (max ER)
V_{driver}=1.5V, R_{c}=50 Ωμm
   4 segments having a length of 20 μm if the thickness of the dielectric layer is tₒₓ=6 nm EOT. FOM=2.675 (IL˜2.2 dB).
   3 segments having a length of 56 μm if the thickness of the dielectric layer is tₒₓ=15 nm EOT. FOM=0.7972 (IL˜7.5 dB)
V_{driver}=1.5V, R_{c}=200 Ωμm
   5 segments having a length of 20 μm if the thickness of the dielectric layer is tₒₓ=9 nm EOT. FOM=1.51 (IL˜4 dB).
   4 segments having a length of 44 μm if the thickness of the dielectric layer is tₒₓ=15 nm EOT. FOM=0.7972 (IL˜7.5 dB)

From the above it is clear that realizing an optical modulator with the parameters of the invention allows to achieve the desired goals in bandwidth and modulation efficiency.

1. A segmented optical modulator, comprising:
a waveguide where electromagnetic radiation to be modulated is adapted to travel along a travelling direction;
between 2 and 30 modulating segments, each segment comprising:
a first layer of graphene and a second layer of graphene, a portion of the first layer of graphene overlaying a portion of the second layer of graphene and the first and second layers of graphene overlaying a portion of the waveguide;
a dielectric layer interposed between the first layer of graphene and the second layer of graphene, the dielectric layer having a thickness comprised between 6 nm EOT and 15 nm EOT;
a first metal electrode in contact with the first layer of graphene;
a second metal electrode in contact with the second layer of graphene;
wherein a distance between the first electrode and the second electrode is comprised between 650 nm and 1500 nm;
wherein a length of each segment in the travelling direction is comprised between 10 micrometers and 60 micrometers.

2. The segmented optical modulator according to claim 1, wherein the waveguide comprises a core and a cladding and the waveguide core has a thickness comprised between 200nm and 250 nm.

3. The segmented optical modulator according to claim 1, wherein the waveguide is realized in silicon, or in silicon nitride (SiN).

4. The segmented optical modulator according to claim 1, wherein the material in which the dielectric layer is realized comprises at least one of: Al2O3, HF2O3, SiN, SiO2, h-BN, or BN.

5. The segmented optical modulator according to claim 1, wherein the width of the segment is comprised between 650 nm and 1500 nm at 1550 nm operating wavelength.

6. The segmented optical modulator according to claim 1, wherein the first and/or the second electrode are made of at least one of: Gold, Nickel, Palladium, Aluminum, Copper, Tungsten or alloys thereof.

7. The segmented optical modulator according to claim 1, wherein the distance between the first metal electrode and the second metal electrode is equal to or longer than the width of each segment.

8. A method to modulate an electromagnetic radiation, comprising:
providing the segmented optical modulator according to claim 1;
inputting an electromagnetic radiation having a wavelength between 1260 nm and 1625 nm in the waveguide.
driving the modulator with a distributed segmented electrical driver.

9. The method according to claim 8, wherein the first electrode and second electrode of each segment are driven with a voltage comprised between 1 V and 2.5 V.
